(19) United States
(12) Patent Application Publication
(10) Pub. No.: US 2020/0233715 A1
(43) Pub. Date: Jul. 23, 2020

(54) DYNAMICALLY PROVISIONING PHYSICAL HOSTS IN A HYPERCONVERGED INFRASTRUCTURE BASED ON CLUSTER PRIORITY

(71) Applicant: VMWARE, INC., Palo Alto, CA (US)

(72) Inventor: Ravi Kumar Reddy Kottapalli, Bangalore (IN)

(21) Appl. No.: 16/371,146

(22) Filed: Apr. 1, 2019

(30) Foreign Application Priority Data
Jan. 22, 2019 (IN) 201941002611

(51) Int. Cl. G06F 9/50

(52) U.S. Cl. CPC G06F 9/5027

(57) ABSTRACT

Techniques for dynamically provisioning and/or deprovisioning physical hosts in a hyperconverged infrastructure based on cluster priority in hyperconverged infrastructures are disclosed. In one embodiment, a user maps physical hosts in a host pool to respective clusters in the hyperconverged infrastructure. Further the user sets one or more resource utilization threshold limits for each cluster by the user. A management cluster then periodically obtains resource utilization data at a cluster level for each cluster. The management cluster then dynamically provisions and/or deprovisions one or more physical hosts to one or more clusters in the hyperconverged infrastructure using the mapped physical hosts in the host pool based on the obtained resource utilization data and the set one or more resource utilization threshold limits.

### RELATED APPLICATIONS

Benefit is claimed under 35 U.S.C. 119(a)-(d) to Foreign Application Serial No. 201941002611 filed in India entitled “DYNAMICALLY PROVISIONING PHYSICAL HOSTS IN A HYPERCONVERGED INFRASTRUCTURE BASED ON CLUSTER PRIORITY”, on Jan. 22, 2019, by VMWARE, Inc., which is herein incorporated in its entirety by reference for all purposes.

### TECHNICAL FIELD

The present disclosure relates to hyperconverged infrastructure environments, and more particularly to methods, techniques, and systems for dynamically provisioning of physical hosts based on cluster type and/or workload priority in hyperconverged infrastructure environments.

### BACKGROUND

A hyperconverged infrastructure is a rack-based system that combines compute, storage and networking components into a single system to reduce data center complexity and increase scalability. Multiple nodes can be clustered together to create clusters and/or workload domains of shared compute and storage resources, designed for convenient consumption. However, existing hyperconverged infrastructures require manual provisioning of physical hosts in a host pool to the clusters based on cluster type and/or workload requirements in the hyperconverged infrastructure. Oftentimes, a user, such as an IT administrator may be required to provision physical hosts manually based on a cluster type and/or workload priority requirement and this can be a very time-consuming process. Further, the user may have to manually check resource utilization of each cluster and then manually provision and/or deprovision the physical hosts in the host pool to the clusters.

### BRIEF DESCRIPTION OF THE DRAWINGS

FIG. 1 depicts a block diagram of a computing system in which one or more embodiments of the present invention may be implemented;

FIG. 2 depicts an example host pool table;

FIG. 3 depicts an example W2H mapping table created by a W2H agent;

FIG. 4 depicts another example block diagram of a computing system in which one ore more embodiments of the present invention may be implemented;

FIG. 5 depicts a flow diagram of a method of dynamically provisioning physical hosts in a hyperconverged infrastructure based on cluster priority, according to an embodiment; and

FIG. 6 is a block diagram of an example computing system including a non-transitory computer-readable storage medium, storing instructions to dynamically provision physical hosts in a hyperconverged infrastructure based on cluster priority.

The drawings described herein are for illustration purposes only and are not intended to limit the scope of the present subject matter in any way.

### DETAILED DESCRIPTION

Embodiments described herein may provide an enhanced computer-based and network-based method, technique, and system for dynamically provisioning physical hosts in a hyperconverged infrastructure based on cluster priority. A cluster is a collection of resources (such as nodes, disks, adapters, databases, etc.) that collectively provide scalable services to end users and to their applications while maintaining a consistent, uniform, and single system view of the cluster services. Example cluster may be a stretched cluster, a multi-AZ cluster, a metro cluster, or a high availability (HA) cluster that crosses multiple areas within a local area network (LAN), a wide area network (WAN) or the like.

By design, a cluster is supposed to provide a single point of control for cluster administrators and at the same time the cluster is supposed to facilitate addition, removal, or replacement of individual resources without significantly affecting the services provided by the entire system. On one side, a cluster has a set of distributed, heterogeneous physical resources and, on the other side, the cluster projects a seamless set of services that are supposed to have a look and feel (in terms of scheduling, fault tolerance, etc.) of services provided by a single large virtual resource. However, existing hyperconverged infrastructures require manual provisioning of physical hosts in a host pool to the clusters based on cluster type and/or workload requirements in the hyperconverged infrastructure. Oftentimes, a user, such as an IT administrator may be required to provision physical hosts manually based on a cluster type and/or workload priority requirement and this can be a very time-consuming process. Further, the user may have to manually check resource utilization of each cluster and then manually provision the physical hosts in the host pool to the clusters. Furthermore, existing hyperconverged infrastructures do not have any mechanism to reserve and/or designate physical hosts in the host pool to the clusters for use based on resource utilization in the clusters.

In public and private clouds there can be several thousand physical hosts in one cluster and the physical hosts, in such a scenario, may need to be provisioned and/or deprovisioned from host pools to reduce downtime. Doing such configuration, allocation and provisioning manually can be very tedious, impractical and unreliable. Any mistake in configuration, allocation, provisioning, and/or deprovisioning of the physical hosts to the clusters can seriously impact the datacentre and/or public/private cloud operation and may significantly increase down-time.

System Overview and Examples of Operation

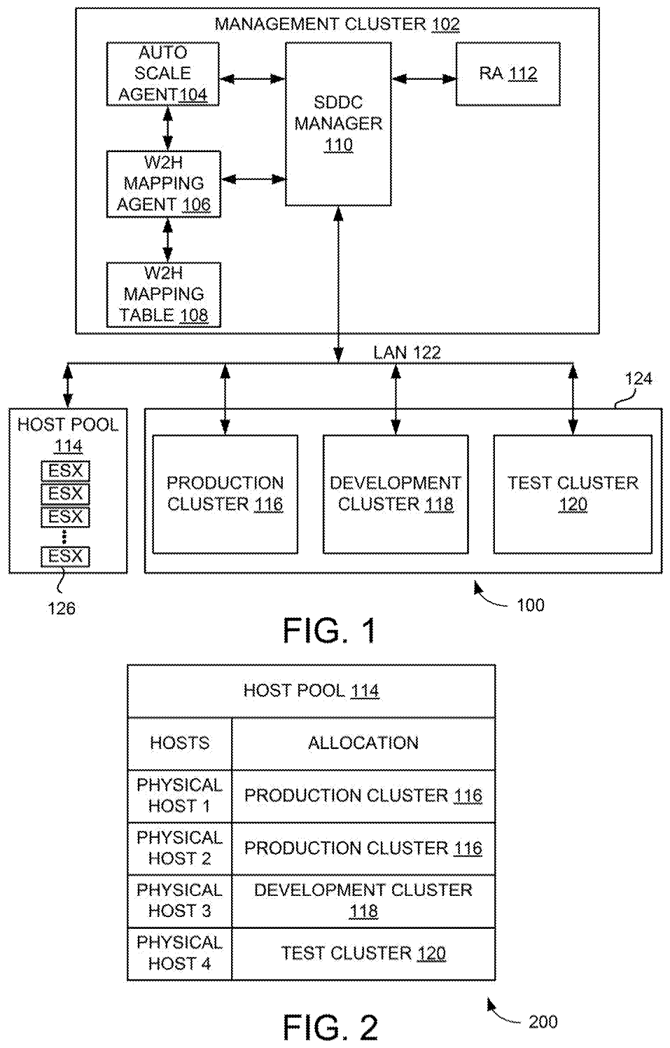

FIG. 1 is a system view of an example block diagram of a hyperconverged infrastructure 100 illustrating a management cluster 102, one or more clusters 124 (for example, a production cluster 116, a development cluster 118, and a test cluster 120) and a host pool 114. Example cluster may be a stretched cluster, a multi-AZ cluster, a metro cluster, or a high availability (HA) cluster that crosses multiple areas within local area networks (LAN) 122. It can be envisioned that the cluster may also cross multiple areas via a wide area network (WAN). As shown in FIG. 1, management cluster 102 may include an auto scale agent 104, a W2H mapping agent 106, a W2H mapping table 108, a software-defined data center (SDDC) manager 110, and a resource aggregator (RA) 112 that are communicatively connected to host pool 114 and one or more clusters 124 via LAN 122. Further as shown in FIG. 1, host pool 114 may include one or more physical hosts 126. Example physical hosts 126 may include, but not limited to, physical computing devices, virtual machines, containers, or the like.

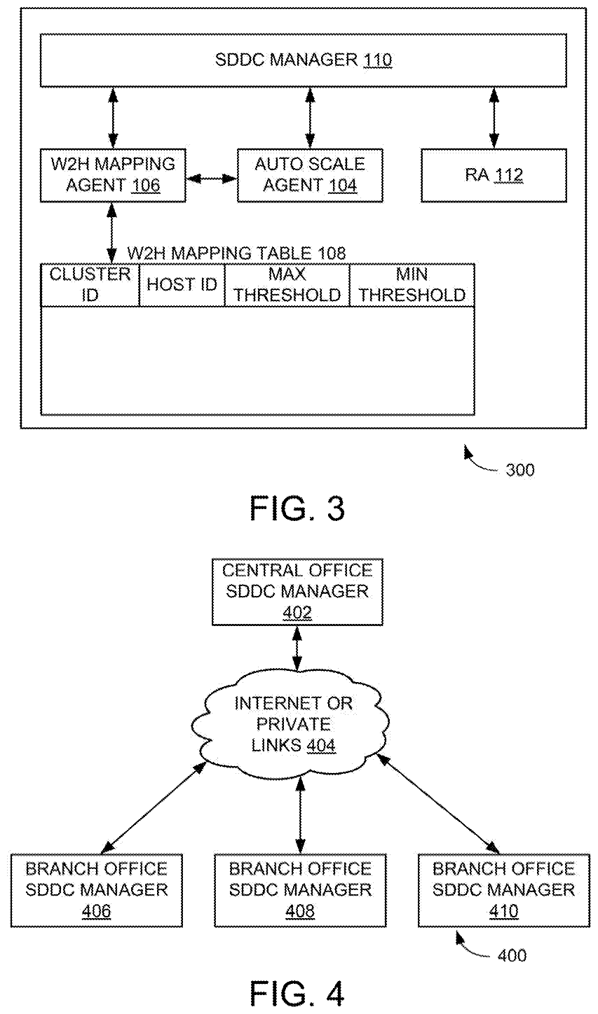

In operation, a user maps physical hosts 126 in host pool 114 to respective clusters 116, 118, and 120 in hyperconverged infrastructure 100. Example mapping table 200 created by a user is shown in FIG. 2. In the example mapping table 200 shown in FIG. 2, user has assigned physical hosts 1 and 2 to production cluster 116, a physical host 3 to development cluster 118 and a physical host 4 to test cluster 118. Example user may be an information technology (IT) administrator. Further in operation, user sets one or more resource utilization threshold limits for each cluster. In some examples, user may set a minimum resource utilization threshold limit and a maximum resource utilization threshold limit for each cluster as shown W2H mapping table 108 (FIGS. 2 and 3) based on historical knowledge. The term “resource utilization” refers to central processing unit, memory and/or storage utilization information. Also, the term “resource utilization may refer to consumption at a system level, a site level, a rack level, a cluster and/or a physical host level. In other examples, the one or more resource utilization limits may be set using artificial intelligence (AI) or machine learning techniques.

User may create a workload-to-physical host (W2H) mapping table 108 including the physical hosts 126 in the host pool 114 along with associated cluster 116, 118 and 120 and one or more resource utilization threshold limits. Further during operation, W2H mapping agent may generate a unique cluster identifier (id) to each cluster and associate the generated unique cluster id with a physical host id. Example physical host id is a physical host serial number or any other id that is unique to a physical host. In some examples, physical hosts 126 in the host pool 124 may be mapped to respective clusters 116, 118, and 120 in the hyperconverged infrastructure 100 and set the associated one or more resource utilization threshold limits determined using artificial intelligence and machine learning during operation.

In operation, W2H mapping agent 106 may maintain W2H mapping table 108 as shown in FIG. 3. W2H mapping agent 106 may generate a unique id for each of one or more clusters 124 as shown in W2H mapping table 108 (FIG. 3). Further as shown in W2H mapping table 108 (FIG. 3), when a user maps physical hosts to respective clusters 116, 118, and 120, W2H mapping agent 106 may also associate each physical host id with an associate generated unique cluster id.

Further in operation, management cluster 102 may periodically obtain resource utilization data at a cluster level for each cluster 116, 118, and 120. In some embodiments, the W2H mapping agent 106 may obtain resource utilization data for one or more clusters 124 from RA 112 as shown in FIGS. 1 and 3.

Furthermore, in operation, management cluster 102 dynamically provisions and/or deprovisions one or more physical hosts 126 to one or more clusters 124 in the hyperconverged infrastructure 100 using the mapped physical hosts in the host pool 114 based on the obtained resource utilization data and the set one or more resource utilization threshold limits. In some embodiments, management cluster 102 may send a resource request call upon the resource utilization reaching the set maximum resource utilization threshold limit at a cluster 116, 118, and 120.

Upon receiving the resource request, management cluster 102 may prepare one or more physical hosts 126 in the host pool 114 based on the mapped physical hosts and the resource utilization data in the W2H mapping table 108. In some embodiments, SSDC manager 110 may prepare one or more physical hosts 126 based on imaging, networking, domain name system (DNS), network time protocol (NTP) and physical network interface card (NIC) requirements of the cluster. Example imaging of the one or more physical hosts 126 may be based on an associated cluster in the hyperconverged infrastructure 100. Further SDDC manager 110, upon receiving the resource request, may pre-configure the one or more physical hosts 126 based on the imaging, networking, domain name system (DNS), network time protocol (NTP) and physical network interface card (NIC) requirements of the cluster.

In some embodiments, W2H mapping agent 106 dynamically determines a number of physical hosts required to run a current workload associated with a cluster 116, 118, and 120. W2H mapping agent 106 may then move the current workload on to required physical hosts and any remaining physical hosts in the cluster may be de-provisioned and moved to the host pool 114. In some embodiments, SDDC manager 110 may determine a number of physical hosts needed for preparing and pre-configuring based on artificial intelligence (AI) and/or machine learning techniques. SDDC manager 110 then pre-configures the determined number physical hosts 126 with any required Kernel Adapters or other networking pre-requests associated with the cluster.

Management cluster 102 may then dynamically provision one or more prepared physical hosts 126 in the cluster 116, 118, and 120. In these embodiments, SDDC manager 110 may periodically monitor and obtain resource utilization data at a cluster level for each cluster via RA 112. SDDC manager 110 may then send a resource request to W2H mapping agent 106. W2H mapping agent 106 may then initiate a request to auto scale agent 104 to dynamically provision the cluster 116, 118, and 120 based on the W2H mapping table 108.

Also, in operation, management cluster 102 may send a deprovisioning request upon the resource utilization reaching the minimum resource utilization threshold limit at a cluster 116, 118, and 120. Management cluster 102 may then dynamically deprovision the one or more physical hosts 126 in the cluster 116, 118, and 120 based on the mapped physical hosts and the resource utilization data.

Management cluster 102 may dynamically change imaging and/or networking requirements to the mapped physical hosts 126 in the host pool 114 upon a change to the imaging and/or networking requirements to a physical host in a cluster 116, 118, and 120.

FIG. 4 is a system view of another example block diagram of a mobile robot fleet management system 400 illustrating a central office SDDC manager 402 and branch office SDDC managers 406, 408 and 410 that are communicatively coupled via Internet, public or private communication links 404. During operation, central office SDDC manager 402 may act as a management station and control and coordinate functions of clusters and/or workloads at branch office locations via branch office SDDC managers 406, 408 and 410. In these embodiments, central office SDDC manager 402 may maintain a separate W2H mapping table 108 for associated with each branch office location. The communications between the central office SDDC manager 402 and branch office SDDC managers 406, 408, and 410 maybe communicated via private, public and/or dedicated communication links, such as shown in FIG. 4. Further in these embodiments, physical hosts may be prepared using locally stored images at the branch office locations.

The embodiments described also can be practiced without some of the specific details described herein, or with other specific details, such as changes with respect to the ordering of the logic, different logic, different architectures, or the like. Thus, the scope of the techniques and/or functions described is not limited by the particular order, selection, or decomposition of aspects described with reference to any particular routine, module, component, or the like.

Example Processes

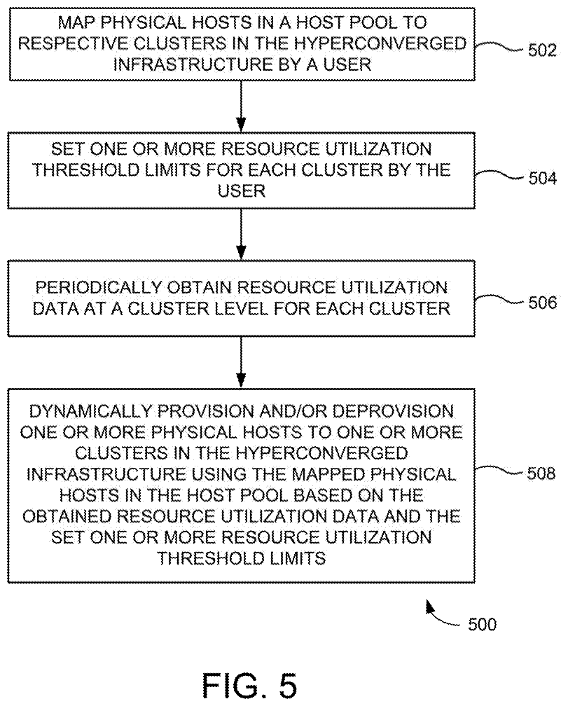

FIG. 5 is an example flow diagram 500 illustrating dynamically provisioning and/or deprovisioning physical hosts in a hyperconverged infrastructure based on cluster priority. The process depicted in FIG. 5 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, physical hosts in a host pool are mapped to respective clusters in the hyperconverged infrastructure by a user. At step 504, one or more resource utilization threshold limits are set for each cluster by the user. At 506, resource utilization data at a cluster level is obtained periodically for each cluster. At 508, one or more physical hosts are dynamically provisioned/deprovisioned to one or more clusters in the hyperconverged infrastructure using the mapped physical hosts in the host pool based on the obtained resource utilization data and the set one or more resource utilization threshold limits.

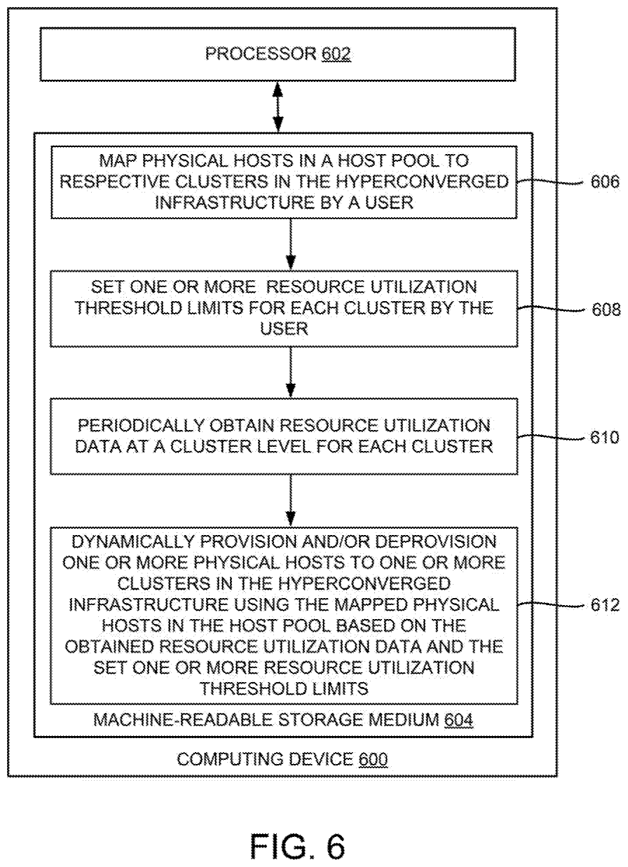

FIG. 6 is a block diagram of an example computing device 600 including non-transitory computer-readable storage medium, storing instructions for dynamically provisioning/deprovisioning physical hosts in a hyperconverged infrastructure based on cluster priority. The computing device 600 may include a processor 602 and a machine-readable storage medium 604 communicatively coupled through a system bus. The processor 602 may be any type of central processing unit (CPU), microprocessor, or processing logic that interprets and executes machine-readable instructions stored in the machine-readable storage medium 604. The machine-readable storage medium 604 may be a random-access memory (RAM) or another type of dynamic storage device that may store information and machine-readable instructions that may be executed by the processor 602. For example, the machine-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, the machine-readable storage medium 604 may be a non-transitory machine-readable medium. In an example, the machine-readable storage medium 604 may be remote but accessible to computing device 600.

The machine-readable storage medium 604 may store instructions 606-612. In an example, instructions 606-612 may be executed by processor 602 for monitoring the health of the application using historical application health data and application logs. Instructions 606 may be executed by processor 602 to map physical hosts in a host pool to respective clusters in the hyperconverged infrastructure. Instructions 608 may be executed by processor 602 to set one or more resource utilization threshold limits for each cluster. Instructions 610 may be executed by processor 602 to periodically obtain resource utilization data at a cluster level for each cluster in the hyperconverged infrastructure. Further, instructions 612 may be executed by processor to dynamically provision and/or deprovision one or more physical hosts to one or more cluster in the hyperconverged infrastructure using the mapped physical hosts in the host pool based on the obtained resource utilization data and the set one or more resource utilization threshold limits.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method comprising:
mapping physical hosts in a host pool to respective clusters in a hyperconverged infrastructure by a user;
setting one or more resource utilization threshold limits for each cluster by the user;
periodically obtaining resource utilization data at a cluster level for each cluster; and
dynamically provisioning and/or deprovisioning one or more physical hosts to one or more clusters in the hyperconverged infrastructure using the mapped physical hosts in the host pool based on the obtained resource utilization data and the one or more set resource utilization threshold limits.

2. The method of claim 1, wherein setting the one or more resource utilization threshold limits for each cluster, comprises:
setting a minimum resource utilization threshold limit and a maximum resource utilization threshold limit.

3. The method of claim 2, wherein dynamically provisioning the one or more physical hosts in the one or more clusters comprise:
sending a resource request call upon the resource utilization reaching the maximum resource utilization threshold limit at a cluster;
preparing the one or more physical hosts based on the mapped physical hosts and the resource utilization data upon receiving the resource request; and
dynamically provisioning the one or more prepared physical hosts in the cluster.

4. The method of claim 3, wherein preparing the one or more physical hosts based on mapped physical hosts and the resource utilization data comprises:
preparing the one or more physical hosts based on imaging, networking, domain name system (DNS), network time protocol (NTP) and physical network interface card (NIC) requirements of the cluster upon receiving the resource request, and wherein imaging the one or more physical hosts comprises imaging the one or more physical hosts based on an associated cluster in the hyperconverged infrastructure; and
pre-configuring the one or more physical hosts based on the imaging, networking, domain name system (DNS), network time protocol (NTP) and physical network interface card (NIC) requirements of the cluster upon receiving the resource request.

5. The method of claim 4, wherein preparing the one or more physical hosts based on mapped physical hosts and the resource utilization data further comprises:
determining a number of physical hosts needed for pre-configuring based on artificial intelligence and/or machine learning techniques; and
pre-configuring the determined number of physical hosts with any required Kernel Adapters or other networking pre-requests associated with the cluster.

6. The method of claim 1, further comprising:
dynamically changing imaging and/or networking requirements to the mapped physical hosts in the host pool upon a change to the imaging and/or networking requirements to a physical host in a cluster.

7. The method of claim 2, wherein dynamically deprovisioning the one or more physical hosts in each cluster comprises:
sending a deprovisioning request upon the resource utilization reaching the minimum resource utilization threshold limit at a cluster; and
dynamically deprovisioning the one or more physical hosts in the cluster based on the mapped physical hosts and the resource utilization data.

8. The method of claim 1, wherein mapping the physical hosts in the host pool to respective clusters comprises:
creating a workload-to-physical host (W2H) mapping table by a user, wherein the W2H mapping table includes the physical hosts in the host pool; and
generating a unique cluster identifier (id) to each cluster and associating the generated unique cluster id with a physical host id and one or more resource utilization threshold limits upon the user creating the W2H mapping table.

9. The method of claim 1, wherein mapping the physical hosts in the host pool to respective clusters comprises:
mapping the physical hosts in the host pool to respective clusters in the hyperconverged infrastructure and setting the associated one or more resource utilization threshold limits using artificial intelligence and machine learning during operation.

10. A hyperconverged infrastructure system comprising:
a management cluster;
one or more clusters communicatively coupled to the management cluster; and
a host pool, wherein the host pool comprises one or more physical hosts and wherein the host pool is communicatively coupled to the one or more clusters, wherein a user maps physical hosts in a host pool to respective clusters in the hyperconverged infrastructure system, wherein the user sets one or more resource utilization threshold limits for each cluster by the user and the management cluster is to:
periodically obtain resource utilization data at a cluster level for each cluster; and
dynamically provision and/or deprovision one or more physical hosts to one or more clusters in the hyperconverged infrastructure using the mapped physical hosts in the host pool based on the obtained resource utilization data and the set one or more resource utilization threshold limits.

11. The hyperconverged infrastructure system of claim 10, wherein the one or more resource utilization threshold limits comprise:
a minimum resource utilization threshold limit and a maximum resource utilization threshold limit.

12. The hyperconverged infrastructure system of claim 11, wherein the management cluster to:
send a resource request call upon the resource utilization reaching the maximum resource utilization threshold limit at a cluster;
prepare the one or more physical hosts based on the mapped physical hosts and the resource utilization data upon receiving the resource request; and
dynamically provision the one or more prepared physical hosts in the cluster.

13. The hyperconverged infrastructure system of claim 12, wherein the management cluster to:
prepare the one or more physical hosts based on imaging, networking, domain name system (DNS), network time protocol (NTP) and physical network interface card (NIC) requirements of the cluster upon receiving the resource request, and wherein the imaging the one or more physical hosts comprises imaging the one or more physical hosts based on an associated cluster in the hyperconverged infrastructure; and
pre-configure the one or more physical hosts based on the imaging, networking, domain name system (DNS), network time protocol (NTP) and physical network interface card (NIC) requirements of the cluster upon receiving the resource request.

14. The hyperconverged infrastructure system of claim 13, wherein the management cluster to:
determine a number of physical hosts needed for pre-configuring based on artificial intelligence and/or machine learning techniques; and
pre-configure the determined number of physical hosts with any required Kernel Adapters or other networking pre-requests associated with the cluster.

15. The hyperconverged infrastructure system of claim 10, wherein the management cluster further to:
dynamically change imaging and/or networking requirements to the mapped physical hosts in the host pool upon a change to the imaging and/or networking requirements to a physical host in a cluster.

16. The hyperconverged infrastructure system of claim 11, wherein the management cluster to:
send a deprovisioning request upon the resource utilization reaching the minimum resource utilization threshold limit at a cluster; and
dynamically deprovision the one or more physical hosts in the cluster based on the mapped physical hosts and the resource utilization data.

17. The hyperconverged infrastructure system of claim 10, wherein the management cluster to:
create a workload-to-physical host (W2H) mapping table by a user, wherein the W2H mapping table includes the physical hosts in the host pool; and
generate a unique cluster identifier (id) to each cluster and associating the generated unique cluster id with a physical host id and one or more resource utilization threshold limits upon the user creating the W2H mapping table.

18. The hyperconverged infrastructure system of claim 10, wherein the management cluster to:
map the physical hosts in the host pool to respective clusters in the hyperconverged infrastructure and setting the associated one or more resource utilization threshold limits using artificial intelligence and machine learning during operation.

19. A non-transitory machine-readable storage medium encoded with instructions that, when executed by a processor, wherein a user maps physical hosts in a host pool to respective clusters in a hyperconverged infrastructure, and wherein the user sets one or more resource utilization threshold limits for each cluster, cause the processor to:
periodically obtain resource utilization data at a cluster level for each cluster; and
dynamically provision and/or deprovision one or more physical hosts to one or more clusters in the hyperconverged infrastructure using the mapped physical hosts in the host pool based on the obtained resource utilization data and the set one or more resource utilization threshold limits.

20. The non-transitory machine-readable storage medium of claim 19, further comprising instructions to:
set a minimum resource utilization threshold limit and a maximum resource utilization threshold limit.

21. The non-transitory machine-readable storage medium of claim 20, further comprising instructions to:
sending a resource request call upon the resource utilization reaching the maximum resource utilization threshold limit at a cluster;
preparing the one or more physical hosts based on the mapped physical hosts and the resource utilization data upon receiving the resource request; and
dynamically provisioning the one or more prepared physical hosts in the cluster.

22. The non-transitory machine-readable storage medium of claim 20, further comprising instructions to:
sending a deprovisioning request upon the resource utilization reaching the minimum resource utilization threshold limit at a cluster; and
dynamically deprovisioning the one or more physical hosts in the cluster based on the mapped physical hosts and the resource utilization data.
